(19) United States
(12) Patent Application Publication
(10) Pub. No.: US 2019/0106937 A1
(43) Pub. Date: Apr. 11, 2019

(54) Window shade mounting system, and three-way mounting unit for use therein

(71) Applicant: Idea81 LLC, Milton, MA (US)

(72) Inventors: Richard van den Bosch, Milton, MA (US); John DePiano, Burlington, MA (US)

(73) Assignee: Idea81 LLC, Milton, MA (US)

(21) Appl. No.: 15/727,572

(22) Filed: Oct. 7, 2017

(51) Int. Cl. E06B 9/42

(52) U.S. Cl. CPC E06B 9/42

(57) ABSTRACT

A window shade system comprises a covering for the architectural opening, a pole on which the covering is wound, and a window frame mounting assembly. The window frame mounting assembly comprises a pair or bracket assemblies, which support the pole, one on each side of the opening. In one embodiment, the bracket assembly comprises a two-piece, three-way mounting unit comprising a first piece, and a second piece configured to mate with the first piece when the unit is positioned in or adjacent the opening. The second piece, which includes a hook to support an end of the pole, can be assembled in three (3) different configurations to achieve a custom mount with respect to the architectural opening (and the facing wall). In particular, and depending on the positioning of the first piece, the mounting unit is positioned to the front side, inner, or outer edges of an architectural frame or to the adjacent facing wall. This is achieved by inserting the second piece into the first piece at a desired orthogonal position such that the hook is positioned in the proper location to support the pole. An alternative one-piece construction for the mounting unit is also provided.

### TECHNICAL FIELD

The subject disclosure relates generally to window shade mounting systems.

### BACKGROUND OF THE RELATED ART

Window coverings or shades come in many styles. Typically, they include a single piece of soft material that is supported for mounting in association with a window (or, more generally, any architectural opening). While window shade mounting systems are well-known, installation is often time-consuming and difficult. In particular, pull-down shades have to be cut to size for either an inside or outside measurement (with respect to the window frame), and the mounting system needs to include (or the user needs to obtain) specific inside or outside (with respect to the window frame) mounts. That the mounting hardware can be affixed to multiple locations in or abutting the window frame complicates the installation, especially for non-professional installers.

### BRIEF SUMMARY

A window shade system comprises a covering for the architectural opening, a pole (or tube) on which the covering is supported, and a window frame mounting assembly. The window frame mounting assembly comprises a pair or bracket assemblies, which support the pole, one on each side of the opening. According to this disclosure, and in a first embodiment, the bracket assembly comprises a unique two-piece, three-way mounting unit comprising a first piece, and a second piece configured to mate with the first piece when the unit is positioned in or adjacent the opening. The first piece comprises a base having an adhesive backing for attaching the first piece to a facing wall or an inside mounting position in a window frame, and an opposed surface from which two or more supports extend. Each support, which is preferably formed as a square-shaped pocket, has three (3) sides, and which correspond to a left mount position, a front mount position, and a right mount position. In this embodiment, the second piece of the mounting unit is a removable hook having two or more prongs that extend from a back surface, with the prongs configured to mate with the supports in one of the three mount positions. The particular mount position depends on where the base is mounted relative to the window frame, and on which side of the window opening the bracket assembly is mounted. An opposed side of the second piece comprises a rounded hook that projects outwardly and accommodates the pole.

According to a second embodiment, a one-piece three-way holder is provided to support the pole on which the covering is supported; the holder is adapted to be positioned on either side of an internal window frame, as well as a front facing panel.

The foregoing has outlined some of the more pertinent features of the subject disclosure. These features should be construed to be merely illustrative. Many other beneficial results can be attained by applying the disclosed subject matter in a different manner or by modifying the subject matter as will be described.

### BRIEF DESCRIPTION OF THE DRAWINGS

FIG. 1 depicts the two-piece, three-way mounting unit of the first embodiment of this disclosure with the first and second piece separated from one another;

FIG. 2 depicts the two-piece, three-way mounting unit of FIG. 1 with the first and second pieces in an assembly when the unit is mounted in or adjacent a window frame; and

FIG. 3 depicts plan views of the two-piece, three-way mounting unit of FIG. 1;

FIG. 4 depicts a window shade system of this disclosure; and

FIG. 5 depicts an alternative embodiment of the three-way mounting unit comprising a one-piece structure adapted to be mounted on either side of an internal window frame, as well as a front facing panel.

### DETAILED DESCRIPTION

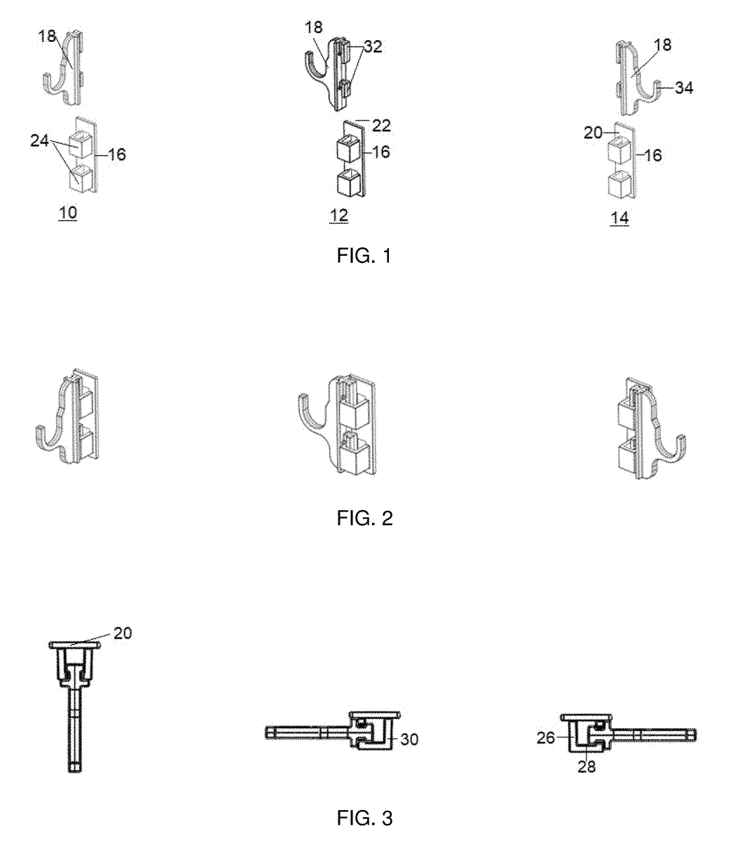

FIG. 1 depicts the two-piece, three-way mounting unit of a first embodiment of this disclosure with the first and second piece separated from one another. This view depicts the three (3) ways that the unit may be positioned, namely, a front facing mount 10, a left facing mount 12, and a right facing mount 14. As depicted, the unit comprises a first piece 16, and a second piece 18 that is configured to mate with the first piece when the unit is positioned in or adjacent the opening. The first piece comprises base 20 having an adhesive backing 22 for attaching the first piece to a facing wall or an inside mounting position in a window frame, and an opposed surface from which two or more supports 24 extend. Each support has three (3) sides 26, 28 and 30, and which correspond to the front mount position 10, the left mount position 12, and the right mount position 14. The second piece 18 of the mounting unit is a removable hook having two or more prongs 32 that extend from a back surface, with the prongs configured to mate with the supports 24 of the first piece 16 in one of the three mount positions. An opposed side of the second piece 18 comprises a rounded hook 34 that projects outwardly and accommodates a pole on which a covering is wound.

FIG. 2 depicts the two-piece, three-way mounting unit of the first embodiment with the first and second pieces 16 and 18 in an assembly when the unit is mounted in or adjacent a window frame. FIG. 3 depicts plan views of the two-piece, three-way mounting unit as shown in FIG. 2. Thus, and according to this embodiment of the disclosure, hook (the second piece) can be assembled in three (3) different configurations to achieve an opposite side mount for each side of an architectural opening. Moreover, depending on the positioning of the first piece, the mounting unit can be positioned to the front side, inner, or outer edges of an architectural frame or to the adjacent wall. This is achieved by inserting the second piece into the first piece at the desired orthogonal position such that the hook 34 is positioned in the proper location to support the pole.

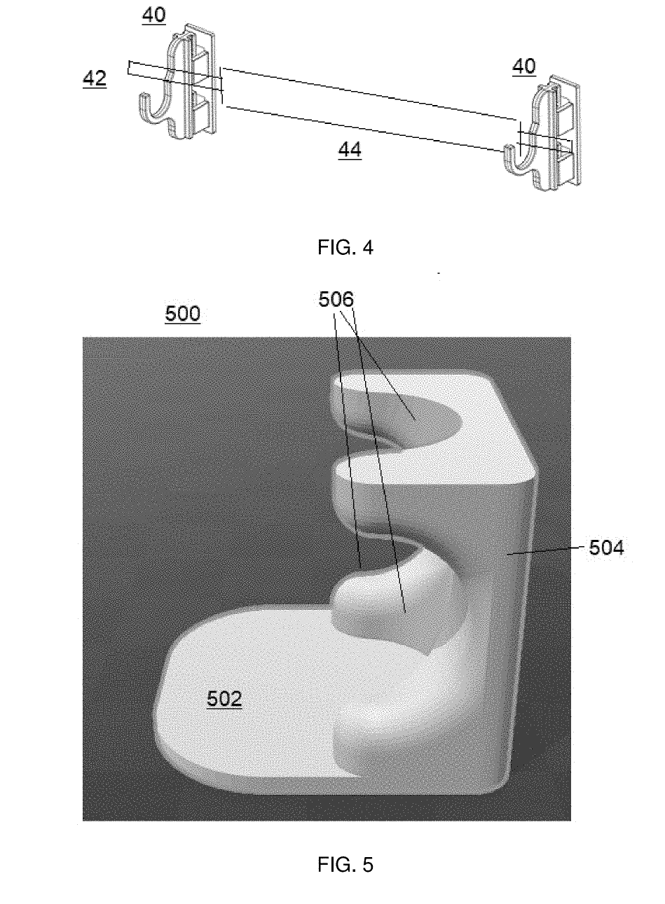

FIG. 4 depicts a window shade system of this disclosure that comprises a pair of units 40, the pole 42, and the window shade 44. There may be multiple pairs of mounting units, and one or more poles. The window shade 44 may be any covering, cloth, banner, poster, or the like. Each of the units 40 comprises the removable hook piece that includes a number of prongs that snap into the multiple elements on the base and fit substantially flush in one of the three (3) mounts. The hook projects outwardly and accommodates the pole 42, or multiple poles for hanging different length shade(s), e.g., made of various materials and weights. The removable hook part (the second piece) can be removed from and reattached to the base to present a 90°, 180° or 270° mount, as shown. The covering is any material, such as cloth vinyl or the like, and that has at least one tubular formation or channel extending along its width proximate and parallel to an upper end or edge thereof for receiving the pole. The pole is typically of a standard length, or adjustable to such a length.

The base component (the first piece) provides a secure foundation that is attached to the wall using the adhesive backed pad. In a preferred implementation, the front portion of the base extends from the rear planer surface with two square- or rectangle-shaped pockets that provide two anchor points, each of which are slightly undercut. The slight undercut allows the hook component (of the second piece) to lightly snap over the top edge of each rectangular pocket to create a secure, but removable attachment. As depicted and described, the pockets allow the user to reposition the hook component in one of three optional positions, providing all required orientations to accommodate each shade position.

Preferably, the pieces of the mounting unit are molded plastic, although other suitable materials or composites may be used.

While the first piece preferably is mounted using an adhesive pad, an alternative fastening approach may be used. Thus, for example, the first piece may include a set of openings through which screws or nails are received.

There may be more than two pockets, in which case there are a corresponding number of prongs.

Although the two-piece construction shown in FIGS. 1-3 is a preferred implementation, an alternative one-piece (integral) structural element 500 is shown in FIG. 5. In this embodiment, the element comprises base 502 having a support element 504 with three substantially U-shaped cutout portions 506 corresponding to the three (3) placement positions (on either side of the inside window frame, and on the inwardly-facing front panel. Depending on where the element 500 is positioned relative to the opening, each element (and typically there will be a pair of them to support the pole) provides the 90°, 180° or 270° mount.

Having described our invention, what we claim is as follows:

1. A mounting unit, comprising:
a first piece, and a second piece configured to be assembled to the first piece in one of three (3) mounting positions, the three (3) mounting positions being one of: a front mount, a left mount, and a right mount;
the first piece comprising a base having an adhesive backing for attaching the first piece to a facing wall or an inside mounting position in a window frame, and an opposed surface from which two or more supports extend, wherein each support is square in shape to form a receiving pocket;
the second piece comprising a removable hook having two or more prongs that extend from a back surface, with the prongs configured to mate with the supports of the first piece in one of the three mounting positions, wherein an opposed side of the second piece comprises a rounded hook that projects outwardly.

2. The mounting unit as described in claim 1 wherein there are two receiving pockets.

3. The mounting unit as described in claim 1 wherein the first and second pieces are formed of molded plastic.

4. The mounting unit as described in claim 1 wherein each pocket provides two anchor points, each of which are undercut to allow the prong of the second piece to lightly snap over a top edge of the pocket to create a secure, but removable attachment.

5. A window shade mounting system, comprising:
a shade;
a pole on which the shade is wound; and
two or more mounting units for supporting the pole, wherein each mounting unit comprises a structural element that provides mutually-orthogonal support surfaces, wherein each mounting unit is adapted to be mounted in one of three (3) mounting positions, the three (3) mounting positions being one of: a front mount, a left mount, and a right mount.

6. The window shade mounting system as described in claim 5 wherein each mounting unit comprises:
a first piece, and a second piece configured to be assembled to the first piece in one of three (3) mounting positions;
the first piece comprising a base having an adhesive backing for attaching the first piece to a facing wall or an inside mounting position in a window frame, and an opposed surface from which two or more supports extend, wherein each support is square in shape to form a receiving pocket;
the second piece comprising a removable hook having two or more prongs that extend from a back surface, with the prongs configured to mate with the supports of the first piece in one of the three mounting positions, wherein an opposed side of the second piece comprises a rounded hook that projects outwardly to support an end of the pole.
